(19) United States
(12) Patent Application Publication
(10) Pub. No.: US 2006/0165012 A1
(43) Pub. Date: Jul. 27, 2006

(54) Method for organizing the topology of a network with a multiplicity of stations grouped in clusters

(76) Inventor: Jorg Habetha, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/509,978

(22) PCT Filed: Mar. 28, 2003
(86) PCT No.: PCT/IB03/01136

§ 371 Date: Mar. 21, 2005

(30) Foreign Application Priority Data
Apr. 2, 2002 (DE) 10214629.2

(51) Int. Cl. H04J 3/08; H04J 1/10; H04B 7/14; H04L 12/28

(52) U.S. Cl. 370/254; 370/315

(57) ABSTRACT

A method for organizing the topology of a network with a multiplicity of stations grouped in clusters, with the following steps: provision of a system of rules that define the arrangement of stations in clusters; classification of the stations into one or more categories in accordance with the rules and - - - arrangement of the stations in clusters on the basis of this classification; determination of changes affecting the topology of the network; adaptation, taking account of the rules, of at least the arrangement of the stations in the clusters on the basis of the changes; is characterized in that: a multiplicity of permitted topology changes of the network are pre-defined; at least one of the input variables for the rules is coded by fuzzy logic, dual logic or other logic; and at least one of the rules generates at least one output variable from coded input variables as a function of the changes affecting the topology of the network; each of said output variables being a decision variable for a permitted network topology change to be

The invention relates to a method for organizing the topology of a network with a multiplicity of stations grouped in clusters, with the following steps:

provision of a system of rules that define the arrangement of stations in clusters;

classification of the stations into one or more categories in accordance with the rules and arrangement of the stations in clusters on the basis of this classification;

determination of changes affecting the topology of the network;

adaptation, taking account of the rules, of at least the arrangement of the stations in clusters on the basis of the changes.

The classification process in wireless communication is known as “unmonitored learning”. This means that no reference objects with known category assignment exist. In this case, the term “clustering” of objects is generally used. The objects in the case under consideration should be equated with the stations, and the categories with groups of stations. The method is to be tailored specifically to the clustering problem in wireless communication.

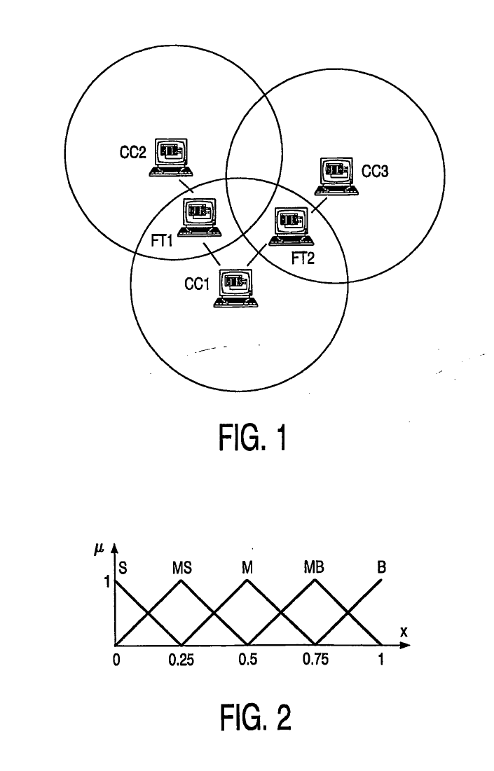

An example of a cluster-based network is shown in FIG. 1. In each cluster, a station, known as the central controller or the cluster center (CC), generates MAC frames and assigns transmission slots to all terminals (WT=wireless terminals, not shown in FIG. 1) in its cluster. On the MAC level, the clusters are connected to so-called forwarders or forwarding terminals (FT), which are located in the overlapping areas of the clusters. Each station must be assigned to a cluster. If this is not possible because fixed cluster boundaries are exceeded, for instance in respect of the geographical interval or the RSS (Received Signal Strength) value of the stations, the stations themselves open a new cluster.

Cluster-based office communication normally implies concerns a so-called real-time application since, when a LAN is operated, communication connections between users are in practice active and must not be interrupted. This means that the clustering algorithm has to react with topology changes to dynamic changes in features within the shortest time. For this reason, iterative algorithms must be critically evaluated here. In particular, there can be no guarantee of how fast an iterative algorithm will converge to a solution. Rule-based methods appear better suited to real-time requirements. For instance, a rule can be used to define which immediate clustering steps should be taken when a particular situation occurs.

There generally exist different classification quality criteria. For instance, the number of correctly classified objects and the unambiguity of the classification are regarded as very important. In office communications, the stability of the classification, i.e. the minimization of handovers (HOs), represents the most important criterion.

The greatest possible homogeneity of the objects within the cluster and the greatest possible heterogeneity of different clusters must also be pursued. As is generally the case, homogeneity here means a relative closeness of the objects in the features domain.

The greatest possible stability of the clusters is a further object of the classification. A certain minimum stability is indispensable because the network would collapse if, for instance, a new CC handover were initiated despite an old CC handover, in which one of the two CCs was involved, not yet being completed. Closely related to this requirement is the question of the number of topology changes undertaken in a time interval. The network can cope with only a certain number of simultaneous topology changes since, otherwise, the connection to some terminals would be severed at least temporarily.

There are four different types of classification, depending on whether the objects and/or the categories are unclearly defined. In the cluster-based network under consideration, the objects may be unclearly defined, i.e. linguistic variables would be introduced as features of the objects. In the case under consideration, the categories are ultimately clearly defined, since a WT (with the exception of the FTs) can always be assigned to only one CC at a time. An unclear (fuzzy) assignment of the WTs to the categories or CCs as additional information can, however, be desirable in order, for instance, to obtain indications of the variation of the assignment values over time, and to institute cluster changes in good time.

Finally, the topology of the network is a dynamically changeable topology, so dynamic cluster analysis methods could be used.

The circumstances outlined give rise to the requirements relating to the method to be selected. The following requirements are absolutely essential:

the method must be real-time capable;

the clusters must have a minimum stability (of the order of 500 ms);

the clustering must, in every time interval, always take account also of the previous cluster apportionment, and cannot suddenly re-cluster the entire network;

the method must take account of hard secondary conditions;

the method must arrange all objects in the cluster;

the method must be capable of operating without training-data sets;

the method must create cluster centers that represent real objects.

Among the desirable features of the method are the following:

the method should be suitable for decentralized execution;

the method should minimize the number of clusters;

it would be desirable if the method were itself learning-capable and could make automatic improvements and react to changed conditions;

the decisions made by the method during the classification should be understandable to an expert.

conversely, it would be good if expert knowledge of a system architect could be incorporated into the method.

The decentralized execution capability of the method then resides at the boundary between essential and non-essential features. In practice, it will probably not be possible to execute the method fully centrally since this would imply heavy loading of the network by the exchange of control information. However, a certain amount of centralization is feasible in a sense that the central controllers could make the decisions concerning topology changes. It can, however, be perfectly practical if, for instance, the decision concerning cluster changes (WT-HO) is taken completely autonomously and hence decentrally by the terminals.

The problem can therefore also be expressed as a decision or control problem as to whether and at what time events of this kind are to be initiated by a station.

Apart from a minimization of topology changes, the aims of the method should definitely also include a minimization of the number of clusters in order to avoid unnecessary forwarding traffic between the clusters.

With this in mind, it is an object of the present invention to develop a method of the kind set forth such a way that it is optimized for office communication but does not exclude other applications. In particular, unmonitored dynamic fuzzy clustering is to take place.

The object is achieved in accordance with the invention in that:

a multiplicity of permitted topology changes of the network are pre-defined;

at least one of the input variables for the rules is coded by fuzzy logic, dual logic or other logic;

at least one of the rules generates at least one output variable from coded input variables as a function of the changes affecting the topology of the network;

each of said output variables being a decision variable for a permitted network topology change to be made.

Preferably, the at least one input variable is fuzzy-coded.

The information is thereby output as to whether a CC, WT or FT handover is being undertaken, whether a new cluster is being opened or an old one closed, and whether an FT is being created or deleted. The basis of the method is that applications are considered in which the main emphasis is on the arrangement of already classified dynamic objects rather than newly added ones. In this case, the assignment of an object to a cluster is already known from the last time interval. Instead of re-classifying the object in the next time interval, the only action is to investigate whether a change need be undertaken to this assignment or to the cluster structure as a whole.

Since the network concept requires an overlapping of the clusters and the setting up of corresponding FTs, the following topology changes are additionally defined according to a further preferred embodiment of the invention:

creation of a forwarder;

deletion of a forwarder;

transfer of the forwarder function to a different station.

In the method in accordance with the invention, the output variables of the rules do not define the cluster assignment of the objects, but determine whether a topology change is undertaken or not. The basis of the method is that applications are considered in which the main emphasis is on the arrangement of already classified dynamic objects rather than newly added ones. In this case, the assignment of an object to a cluster is already known from the last time interval. Instead of re-classifying the object in the next time interval, the only action is to investigate whether a change need be undertaken to this assignment or to the cluster structure as a whole.

Preferably, the fuzzy-coded input variable is a linguistic variable.

Equally preferred is that at least one of the rules is of the Mamdani type. The reason is that, using rules of this kind, decisions on certain clustering events are taken in the form of “yes/no” decisions, for which linguistic output variables are ideally suited.

The invention also relates to a network with a multiplicity of stations which are grouped in clusters with:

a memory device in at least one of the stations in which a system of rules defining the arrangement of stations in clusters is stored;

a device for classifying the stations into one or more categories in accordance with the rules, and for arranging the stations in clusters on the basis of the classification;

a device for determining changes affecting the topology of the network;

a device for adapting at least the arrangement of the stations in clusters on the basis of the changes while, observing the rules;

characterized in that:

a multiplicity of permitted network topology changes is stored in the memory device;

a device is provided for coding at least one of the input variables for the rules is provided in accordance with fuzzy logic, dual logic or other logic;

wherein at least one of the rules generates at least one output variable from coded input variables as a function of the changes affecting the topology of the network, and each of these output variables is a decision variable for a permitted network topology change to be made.

Fuzzification of the at least one input variable is preferred.

It is preferred that every cluster includes a central controller (CC) which is a station of the network, wherein the controller itself executes at least the topology changes relating to its existence and/or function.

The network is advantageously characterized in that at least one station is provided as a forwarder which participates in the communication of two clusters, wherein the network permits the following as additional topology changes:

creation of a forwarder;

deletion of a forwarder;

transfer of the forwarder function to a different station.

The invention also relates to the use of a previously defined method in conventional data analysis, wherein the stations are the objects of the data analysis.

An important difference from the preferred application consists in the fact that, in data analysis, the classification is undertaken by an outside “global” observer, whereas, in office communication, the classification takes place in decentralized fashion in the CCs and, where applicable, even the WTs.

The application is further characterized in that, in the wireless network, the cluster centers, as central controllers, always simultaneously represent objects or stations. In the general case of data analysis, on the other hand, the CCs may represent virtual points in the features domain.

In conventional data analysis, furthermore, no secondary conditions generally exist as regards the maximum spacing of the objects of a cluster in the features domain. In the cluster-based LAN, fixed cluster boundaries of this kind exist, however, in respect of, for example, the geographical interval or the RSS value of the stations. This does not mean, however, that the assignment of the objects to a cluster can only assume the values 0 or 1, but only that an assignment value 0 inevitably applies outside the cluster boundary.

One especially important difference between data analysis and the application example lies in the requirements regarding the maximum duration of the clustering process. In data analysis, the main emphasis is on the end result of as optimum a classification as possible. The duration of the classification process in order to achieve this result plays only a subordinate role here.

As regards the number of categories, there exists a further difference between the general and the specific case. Generally, the number of categories is derived using various quality criteria of the classification. From all possible numbers of categories, the one that best fulfils the quality criteria is selected. In the specific case of the cluster-based network, the number of clusters itself represents a quality criterion, since this number has to be minimized.

The great advantage of knowledge-based or rule-based methods resides in their real-time capability, which has been demonstrated many times in practice in the context of fuzzy control. Rule-based methods also appear flexible enough to be able to guarantee the stability of the cluster assignment and a restriction of the number of simultaneous topology changes. A further advantage of rule-based methods can be seen in the fact that hard secondary conditions can be taken into account in the form of rules. Furthermore, all objects can be assigned to a cluster if the rules are formulated accordingly. Knowledge-based methods generally require no training-data set if the knowledge acquisition is undertaken by an expert, for example. Finally, with a rule-based system, creation of the CCs can be undertaken by selection of suitable objects, as is required in the application under consideration. By virtue of the complexity of the application, it would appear advantageous to incorporate expert knowledge into the method in order that the method is capable of learning from past errors, or has self-optimizing properties. The decision-making of the method should also be understandable to an expert.

Traditional rule-based classification methods undertake an assignment of each individual object into one or more categories. The output variables of the rules indicate, for instance, the cluster to which an object or a station is assigned. In the case of a dynamic classification problem, according to this variant a check would have to be made in each time interval as to whether the cluster output by the rules coincides with the cluster to which the station was assigned in the previous time interval. If this were not the case, a cluster change would have to be initiated. In the case of dynamic classification, a rule-based method of this kind appears extremely laborious, since the objects are initially assigned to clusters and only subsequently is a check made as to whether a change of the situation thus far is in fact the case.

If the output variables of the rules are fuzzy assignment values of the objects to the clusters, a cluster change could, for instance, be initiated if the difference between the assignment value of an object to a (new) cluster and the assignment value to the previous cluster exceeds a certain value. With this rule type too, the objects would initially be assigned to clusters and only thereafter could a check be made as to whether a cluster change should be initiated.

A further disadvantage of conventional rule-based classification methods can be seen in the fact that the dynamic change in the number of clusters that is necessary in dynamic classification is difficult to realize.

The basic idea of the method in accordance with the invention consists in considering the dynamic topology changes instead of the static cluster assignments of the objects. The method in accordance with the invention thus resembles more closely a fuzzy control approach than a traditional rule-based classification method, since a dynamic classification problem is involved, in which values that are used as input variables in the rules are taken from a dynamic process. The output variables of the rules determine the decision as to topology changes. A topology change represents an intervention in the dynamic system which can be regarded as control. It is apparent that, when things are considered in this way, the dynamic classification problem can be interpreted as a fuzzy control problem.

According to S. Mann, “Ein Lernverfahren zur Modellierung zeitvarianter Systeme mittels unscharfer Klassifikation” (“A learning method for modeling time-variant systems by means of fuzzy classification”), dissertation, Karl-Marx-Stadt Technical University, 1983, a distinction is made between the following dynamic changes in cluster structure:

the creation of new clusters,

the merging of clusters,

the division of clusters,

the deletion of clusters,

the shifting of clusters.

It is expedient to consider a further dynamic change which does not inevitably result in a change of the cluster structure:

a change in the category assignment of an object.

In the case of a fuzzy assignment of an object to one or more categories, this event can be interpreted as the undershooting or exceeding of a certain assignment boundary value. From a technical viewpoint, the creation of new clusters and the division of clusters on the one hand, and the merging of clusters and the deletion of clusters on the other, each represent similar problems. When new clusters are created and when clusters are divided, a new CC is formed in each case. In both cases, an already existing CC should make the decision to create a new CC and request a terminal to take over the CC function. Subsequently, WTs in the vicinity of the new CC can independently change to the new cluster. In the case of the merging and the deletion of clusters, an existing CC in each case relinquishes the CC function and becomes a WT. The merging can thus be attributed to the change of all WTs in a cluster to a different cluster and the subsequent deletion of the cluster in question.

For these reasons, in accordance with a preferred embodiment of the method in accordance with the invention, a distinction is made between the following topology changes:

the creation of a new cluster,

the deletion of a cluster,

the shifting of a cluster, and

e change of category assignment of a station.

Apart from the question of the nature of knowledge representation, the question of acquiring this knowledge also arises. In the case of rule-based knowledge representation, the question of how the rule base can be constructed is, therefore, of equal importance. In this connection, a distinction should be made between three principal categories of methods:

Data-based methods: With these methods, the decisions are made using past experience. Therefor, methods of this kind are only as good as the representative capability of the historical data and the correctness of the decisions made in the past.

Knowledge-based methods: in this case the decisions are made on the basis of human knowledge. For instance, rules could be formulated by an expert.

Model-based methods: methods of this kind are based on a model of the process or at least a measurability of the objectives to be achieved. These are optimization methods in the widest sense, since the aim is to fulfill the objectives as optimally as possible. If measurability of the achievement of objectives is a given, artificial intelligence methods may be used that enable rules to be evaluated and selected on the basis of the achieved objective fulfillment.

Favored for the invention is a knowledge-based approach, which is described below in greater detail; however, a model-based method is also feasible. A structure of the rule base using genetic algorithms will be considered by way of example. This model-based approach could also be used during system operation to improve a rule base produced by an expert, and to adapt it to dynamic changes in system behavior.

In developing a rule-based inference system, the choice of the input and output variables, the assignment functions, the fuzzification and defuzzification mechanisms, the rules and the inference and aggregation operators is essential.

The invention will be further described with reference to examples shown in the drawings, to which, however, the invention is not restricted.

FIG. 1 shows the schematic representation of a cluster-based network;

FIG. 2 shows an example of the assignment function of the input variables;

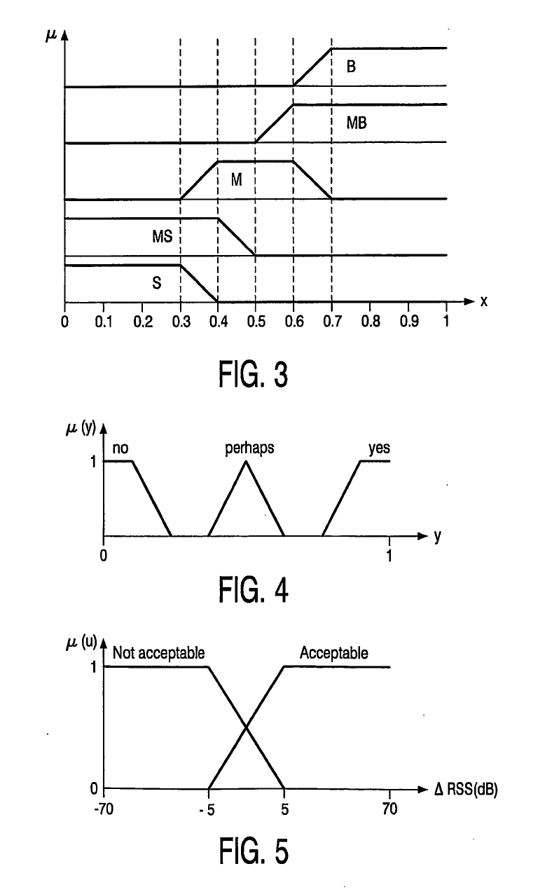

FIG. 3 shows a further example of the assignment function of input variables;

FIG. 4 shows fuzzy output variables as used in the embodiment of the invention;

FIG. 5 shows a graph for fuzzy averaging;

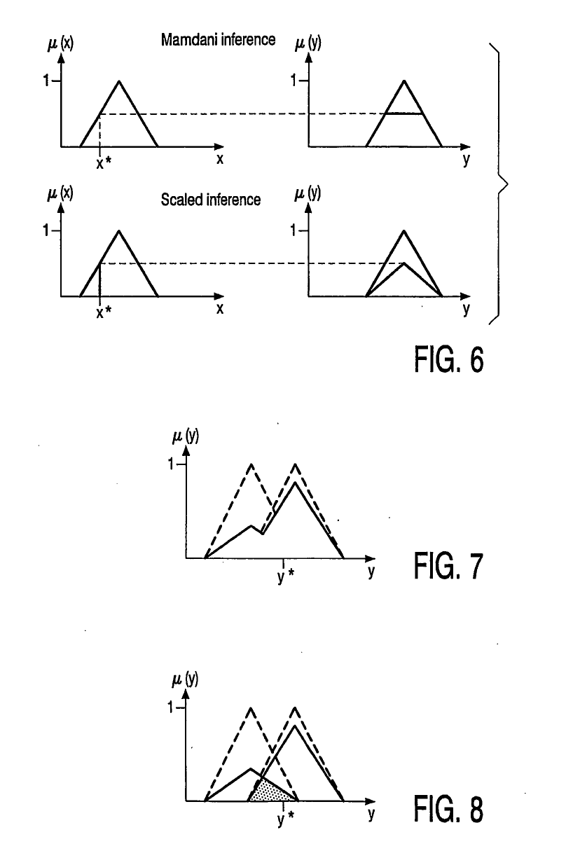

FIG. 6 shows an illustration of Mamdani inference versus scaled inference;

FIG. 7 shows a graph of the center-of-sums method, and

FIG. 8 shows a representation of the center-of-area method.

It has already been established that the knowledge-based and especially rule-based classification methods fulfill all the essential requirements. In addition, however, these methods also have some other desirable properties. The most important property concerns the decentralized execution capability of the methods. It will be demonstrated below that the rules can be used for decentralized decision-making. Another important property of rule-based methods is that rules can generally be easily understood. Expert knowledge can also be incorporated into the rules, or the rules can be produced by an expert directly. Finally, it is possible to adapt the rules automatically and to improve them in the course of the dynamic classification process.

Below, reference is made to a network similar to the one shown in FIG. 1. In the example under consideration, fuzzy output variables (CC creation, CC deletion, CC handover and WT handover) are established for only four of the seven previously defined topology changes. The three FT-related topology changes are controlled by means of a special algorithm, which is described in the application “Netzwerk mit mehreren Sub-Netzwerken zur Bestimmung von Brücken-Terminals” (“Network with multiple sub-networks for determination of bridge terminals”) (DE 100 53 854.1). The input variables of the algorithm or features of the objects and stations are first defined. In the case of local networks, the following are some of the possible variables:

level (RSS value) at which the own CC is received, or

the variation of the RSS value at which the own CC was received in the last time intervals (trajectory),

RSS values at which neighboring CCs are received (if CCs other than the own are received),

reception quality or PER at which the own CC is received,

reception quality or PER at which the neighboring CCs are received,

traffic load of the own CC,

traffic load of the neighboring CCs,

number of WTs in the cluster,

average RSS value of a station,

average RSS value of a station in comparison with the neighboring stations,

number of direct neighbors of a station,

number of direct neighbors of a station in comparison with the neighboring stations,

sum of the in-cluster traffic of a station,

sum of the in-cluster traffic of a station in comparison with the neighboring stations,

speed of a station,

time since the last CC handover,

time since the last WT handover or FT handover,

speed of change of the RSS value at which the own CC is received,

type of power supply (socket or battery).

The selection made already implies the incorporation of expert knowledge, and is closely related to the rules created in the next section. Only a brief reference to the possible benefits of the individual input variables will be made here. In the next section, the meaning of the input variables in connection with the rules created will become clearer. The reception level or RSS value of the own CC, the difference between the RSS value of the own CC and the RSS values of the neighboring CCs and the PER serve as criteria for deciding on the cluster assignment of a station. The traffic load in the own and in the neighboring clusters is used as an input variable in order to avoid overloading of individual clusters. In principle, it certainly appears desirable to include in a cluster all users that are connected with one another in order to minimize the forwarding traffic. On the other hand, however, a cluster should not be loaded beyond a certain capacity limit.

The average RSS value of a station is to be understood as the mean value of the reception level for all received stations. This RSS value may, in comparison with the RSS values of the neighboring stations, serve as a criterion for a cluster shift. In addition, the connectivity, i.e. the number of direct neighbors, may be used as the input variable. A further criterion of a cluster change is the in-cluster traffic of a station with its neighboring stations.

The RSS value, connectivity and in-cluster traffic are criteria similar to the degree of a node used in the methods relating to graph theory, since these measured values each represent a sum via edge evaluations to the direct neighbors. These cumulative values are converted into assignment values during the fizzification described below. The sequence of summation and fizzification has here been exchanged for the methods relating to graph theory, which, however, plays no part in linear operations.

One very useful input variable would be the speed of a station, since stations that move at a comparatively high speed are not well suited to be CCs because frequent topology changes would result. Unfortunately, the speed of a terminal is not always available as a measured value. In many cases, categories to which the stations can be assigned in advance can at least be created, e.g. “stationary” versus “mobile” or “mains-operated” versus “battery-operated”.

Using the input variable “Time since the last topology change”, the necessary stability can be conferred on the clusters.

In some dynamic classification methods, trajectories of the characteristic values are used. An example of a trajectory is the “variation of the RSS value”, which is counted as a possible input variable. Owing to the necessary memory involvement and the limited benefit in the application under consideration, however, no trajectories are used here where at all possible. It would, however, be desirable to undertake at least a sliding mean-value formation of the input variables, in order that topology changes are not undertaken on the basis of random events or very brief effects.

To summarize, of the possible input variables mentioned and explained above, the following are used and defined as variables:

“Level CC”: level at which the own CC is received.

“Level neighboring CCs”: level of the neighboring cluster received with the strongest level.

“Level neighboring CC”: level at which a specific neighboring cluster is received (which cluster is referred to is explained in the description of the rule in question).

“Level difference”: difference between the maximum level of a neighboring CC and the level of the previous CC.

“PER CC”: PER at which the own CC is received.

“PER neighboring CCs”: PER of the neighboring cluster received with the smallest PER.

“PER neighboring CC”: PER at which a specific neighboring cluster is received (which cluster is referred to is explained in the description of the rule in question).

“Traffic CC”: traffic in the own cluster. All traffic values used in the decision regarding cluster creation and deletion are sliding mean values in order to eliminate short-term fluctuations.

“Traffic neighboring CCs”: traffic of the neighboring cluster with the smallest traffic volume.

“Traffic neighboring CC”: traffic of a specific neighboring cluster (which cluster is referred to is explained in the description of the rule in question).

“Speed CC”: speed of the previous CC.

“Speed CC candidates”: speed of the slowest CC candidate.

“Speed CC candidate”: speed of a specific CC candidate (which CC candidate is referred to is explained in the description of the rule in question).

“Number of WTs”: the number of WTs associated in a cluster, formulated as a sharp variable.

“WTs supplied”: this input variable is a sharp variable that can assume the value 0 or 1. The value 1 is assumed if all WTs of a cluster could be adequately supplied by another CC. The value 0 is assumed if even just one single WT would not be adequately supplied. The term adequate supply means that the reception level at which the new CC is received exceeds a certain minimum value, and that the new CC is capable of accommodating the WT, including consideration of the traffic load. The latter means that the traffic load in the cluster of the new CC must lie below a certain value even after accommodation of the WT (see section \ref{subsec:verfahren:wissensbasierteregelbasis})}.

“WT supplied”: like the variable “WTs supplied”, this input variable is a sharp variable that can assume the value 0 or 1. It differs from the latter only in that it checks only the supply of a single specific WT by a cluster.

“RSS mean-value difference”: difference between the maximum average RSS value of a CC candidate and the average RSS value of the previous CC.

“In-Cluster traffic difference”: difference between the in-cluster traffic of a CC candidate and the in-cluster traffic of the previous CC.

“Connectivity difference”: difference between the connectivity of the CC candidate and the connectivity of the previous CC.

“Time since CC handover”: time since the last CC handover.

Level CC candidate”: level at which the previous CC receives the CC candidates.

“Level CC candidate to neighboring CCs”: level of the neighboring cluster that receives the CC candidate with the strongest level.

Most input variables are preferably defined as linguistic variables.

The output variables represent decision variables that can assume values of the type “yes/no/perhaps”. According to the previously identified topology changes, the following output variables arise:

“Creation of a new cluster” (yes/no/perhaps)

“Deletion of a cluster” (yes/no/perhaps)

“Shifting of a cluster” (yes/no/perhaps)

“Cluster change of an object” (yes/no/perhaps)

“Creation of a new FT” (yes/no/perhaps)

“Deletion of an FT” (yes/no/perhaps)

“Shifting of an FT” (yes/no/perhaps)

For each of the seven possible topology changes, a signaling procedure must be defined. Below, the signaling procedures are used synonymously with the topology changes:

“CC creation”

“CC deletion”

“CC handover”

“WT handover”

“FT creation”

“FT deletion”

“FT handover”

The WT handover is present in the HIPERLAN/2 standard, and the CC handover procedure has already been incorporated into the standard, as described in, for instance, J. Habetha, A. Hettich, J. Petz and Y. Du “Central controller handover procedure for ETSI-BRAN HIPERLAN/2 ad hoc networks and clustering with quality of service guarantees”, IEEE Annual Workshop on Mobile Ad Hoc Networking & Computing (MobiHOC), pp. 131-132, August 2000. Further output variables, which could, for instance, record the reason for the classification intervention, are also conceivable:

“CC creation reason level?” (yes/no/perhaps)

“CC creation reason traffic?” (yes/no/perhaps)

“CC deletion reason number of WTs?” (yes/no/perhaps)

“CC deletion reason traffic?” (yes/no/perhaps)

“CC handover reason RSS?” (yes/no/perhaps)

“CC handover reason in-cluster traffic?” (yes/no/perhaps)

“CC handover reason connectivity?” (yes/no/perhaps)

“CC handover reason speed?” (yes/no/perhaps)

“WT handover reason level?” (yes/no/perhaps)

“WT handover reason PER?” (yes/no/perhaps)

“WT handover reason level difference?” (yes/no/perhaps)

“WT handover reason traffic?” (yes/no/perhaps)

“ESSENTIAL?” (yes/no/perhaps).

The last of the listed output variables records whether the clustering intervention was essential or not.

For a fuzzification of the input variables, a uniform number of five linguistic terms are selected for all input variables for simplification purposes. These terms can be generally formulated as:

B: Big

MB: Medium Big

M: Medium

MS: Medium Small

S: Small

FIG. 2 shows a possible selection of the assignment functions of the linguistic terms in the interval [0,1].

FIG. 3 shows an alternatively possible selection of the assignment functions. This would have the advantage that, in the rules of the rule base, the term “Medium Big”, for instance, could be used in order to express that a value “Medium Big or greater” is expected. This is possible because the assignment function of the term “Medium Big” in the overall definition range above its break point assumes the value 1. With the exception of the term “Medium”, all other terms can thereby instead be interpreted as “Big or greater”, “Medium Big or greater”, “Medium Small or smaller” and “Small or smaller”.

Below, however, a selection of the assignment functions in accordance with FIG. 2 is assumed. This has the result that, for instance, the expression (“Medium Big” OR “Big”) has to be used in order to express a value “Medium Big or greater”. As an OR-operation, the arithmetic sum of the assignment functions is selected. In this manner, it is achieved that the term (“Medium Big” OR “Big”) likewise assumes an assignment value of 1 for all values above the break point of the function “Medium Big”. For the sake of simplicity, it should initially be assumed here that the same assignment functions of the linguistic terms are used for all input variables in the normalized interval [0,1].

In normalizing the assignment functions, the problem arises of how unlimited definition ranges of the base variables can be mapped on the interval [0,1]. One solution option lies in restricting the definition range of the base variables by sufficiently large values. One option is the use of the tan h as the normalization operator. The tan h maps the entire real numbers on the interval (−1,1). For reasons of computing efficiency, the following form of normalization of variables is undertaken here with an infinite range of values:

$${x}_{norm} = 1 - \frac{1}{1 + α x} \qquad ( 1 )$$

The scalar factor α was selected as being suitable for each specific variable. The variables concerned are all PER-related, speed-related, quantity-related and time-related input variables. A different kind of normalization was selected for the reception-level-related input variables (“level CC”, “level neighboring CCs” and “level neighboring CC”) because in the HIPERLAN/2 standard, a normalization of level values to the so-called Service Level Number (SLN) is already undertaken.

Provision is made in the HIPERLAN/2 standard for the WTs to report to their CC the reception level of all received CCs. To this end, the levels have to be coded as bit sequences. 6 bits have been defined for the transmission of levels. 64 stages (from 0 to 63) are therefore available for coding the level. In accordance with the standard, the level is measured in dBm. A so-called sensitivity of the terminals of −85 dBm is required. The sensitivity designates the minimum reception level at which a device can still just detect arriving PDUs. The coding of the reception level starts slightly below the sensitivity limit at −91 dBm. This level is defined as SLN=0 (and thereby transmitted as the bit sequence 000000). Above −91 dBm, the levels up to −40 dBm are coded in 1 dBm steps, i.e. a level of −40 dBm corresponds to SLN=51 (or the bit sequence 110011). From −40 dBm to −20 dBm, the levels are coded in 2 dBm steps, i.e. signal stage SLN=61 corresponds to a level of −20 dBm. Signal stage SLN=62 identifies all levels>−20 dBm. Signal stage SLN=63 is reserved for future purposes.

The coding of the reception level in the HIPERLAN/2 standard illustrates how a normalization for this input variable of the rule base can be undertaken. Only a division by 62 has to be undertaken in order to normalize the coded values of the base variables to the interval [0,1]. The depicted mapping or normalization specification of the level will be used below.

A further level-related input variable is the “level difference”. With the level coding used (in the form of dimensionless SLNs), it is evident that the “level difference” can assume values from −62 to 62. The normalization specification of the level difference is therefore:

$${x}_{leveldifference}^{norm} = \frac{{x}_{leveldifference}}{124} + 0.5 \qquad ( 2 )$$

As a measure of the reception quality, the PER was stipulated in the previous section. Three PER-related input variables are used (“PER CC”, “PER neighboring CCs” and “PER neighboring CC”). The PER assumes values between 0 and 1. A conversion of the PER is nevertheless expedient since interesting values of the PER lie in the lower range between 0.001 and 0.1 of the definition range. For instance, a PER of one percent, i.e. 0.01, is regarded as acceptable. The following normalization of the PER is therefore proposed here:

$${x}_{PER}^{norm} = \frac{1 - {e}_{PER}^{- 10 x}}{1 - {ⅇ}^{- 10}} \qquad ( 3 )$$

As a result of the conversion, the value range remains at around [0,1], but, for example, a PER of 0.1 yields a normalized value of 0.63 and is thereby “shifted”, as desired, into the middle range of the interval.

For the input variables “traffic CC”, “traffic neighboring CCs” and “traffic neighboring CC”, the traffic load, which lies between 0 and 1 or 0 and 100% of the capacity of a cluster, is used as the base variable. The traffic load measures the relative capacity utilization of a MAC frame. A normalization of the traffic load is not necessary.

The next group of input variables (“speed CC”, “speed CC candidates” and “speed CC candidate”) is defined via the base variable “speed”. The value range in which the speed of the stations can fluctuate depends strongly on the scenario under consideration. For example, vehicle speeds of over 100 km/h are possible in a free-space scenario. Since a network concept for improving office communication is being developed in this work, an indoor scenario, in which pedestrian speeds can be prerequisites, can be assumed. A value of 2 m/s is assumed as the maximum speed. Should a greater speed occur on occasions, this could be mapped on the value 2 m/s. Since the assessment of whether a speed is graded small, medium, big, etc. is to be undertaken intuitively quite uniformly in the interval 0.2 m/s, a linear normalization is undertaken by division by the maximum value of 2 m/s.

A further linguistic input variable is the “number of WTs”. A number of 10 WTs in a cluster is classified as big. For this reason, all figures greater than 10 are mapped on the value 10 (or obtain the assignment value 1 for the term “Big”). Subsequently, all values are normalized to the interval [0,1] by division by the value 10.

The input variable “RSS mean-value difference” is related to the RSS value or level. To this extent, the same coding of the RSS value with values between 0 and 62 is a prerequisite. The input variable under consideration is the difference between the maximum average RSS value of all neighboring stations and the average RSS value of the station under consideration. Like for to the level-difference variables, values for the RSS mean-value difference between −62 and 62 can thus occur. The same normalization specification as in equation (2) is used therefore.

The “cumulative traffic difference” represents the difference between the maximum traffic of all neighboring stations and the traffic of the station under consideration. It appears obvious to measure the traffic either by means of the cumulative data rate of all connections of a station (i.e. the gross bit rate} on the physical layer) or the so-called symbol rate (baud rate} on the physical layer). The symbol rate indicates the actual occupation of transmission capacity. Depending on the modulation method used, different symbol rates may result for the same data rate. The selection of the modulation method takes place adaptively as a function of the connection quality in, for instance, the HIPERLAN/2 system. With a good reception situation, higher-value modulation methods are used, which, with the same data rate, involve a lower symbol rate and thereby a lower capacity occupation. It appears expedient, with the same cumulative data rate, to give preference as a CC to the station that exhibits the better “RSS mean-value difference”, i.e. is better positioned in terms of space. Of the two stations, the one distinguished by the higher “RSS mean-value difference” will, owing to the on-average better reception conditions, probably use the higher-value modulation method and therefore exhibit a lower total-symbol rate. If the symbol rate were selected as the base variable, the station with the highest symbol rate would become the CC, i.e., with the same data rate, the station with the poorer reception conditions would be selected. This does not appear logical. For this reason, the gross data rate and not the symbol rate is selected as the base variable. In the HIPERLAN/2 system, a maximum gross data rate of 54 Mbit/s is possible when the highest-value modulation method is used. The term gross is intended to indicate that the data is not just user data, but also includes coding and control information. The “cumulative traffic difference” can thus assume values between 0 and 54 Mbit/s. A linear normalization would mean a division of all values of the base variables by 54 Mbit/s. Since, however, a difference of around 10 Mbit/s is already classifiable as “Big”, the following normalization is to be used:

$${x}_{traff}^{norm} = \frac{1 - {ⅇ}^{- 10 \frac{xtraff}{54 Mbit / S}}}{1 - {ⅇ}^{- 10}} \qquad ( 4 )$$

The last input variable to be analyzed is the “time since CC HO”. In this respect, it must be remembered that at least around 500 ms has to have passed since the last CC handover. As will become clear in the next section in the context of the construction of the rule base, this means that the lower limit of the supporting quantity of the fuzzy set “Big” must lie above 500 ms. A further requirement is that the normalization must map the upwardly open interval of the time since the last CC handover on the interval [0,1]. These requirements can also be fulfilled by a normalization using an exponential function:

$${x}_{time}^{norm} = 1 - {ⅇ}^{- \frac{xtime}{1 s}} \qquad ( 5 )$$

The assignment functions may also be defined separately via their base variables for each linguistic variable. In this manner, the form of the functions can be specifically selected or optimized in each case. In this case, the assignment functions may be defined either in the normalized form in the interval [0,1] or in a non-normalized form, directly via the relevant base variables. Normalization and denormalization would be dispensed with in the second variant. The final position of the break and zero points of the assignment functions of the individual input variables could only be optimized by simulation runs. Since it cannot be proved in this way whether the shifting of a zero point or a break point of the assignment function would be advantageous in the case of a specific variable, a separate listing of the assignment functions for each individual variable has been dispensed with. Instead, all that was ensured through the particular normalization selected was that the division of the values into the linguistic terms in accordance with FIG. 2 or FIG. 3 as regards each individual base variable corresponds with the intuitive understanding.

As already discussed, rules of the Mamdani type are selected. The output variables of the rules are therefore linguistic variables. These represent decision variables for which the linguistic values “no”, “perhaps” and “yes” are selected.

FIG. 4 shows the assignment functions, which are uniform for all output variables. By contrast with the input variables, an overlapping of the assignment functions is not necessary, since, with output variables, the value of the base variables is not given, but is obtained by defuzzification of the assignment functions. It is therefore unnecessary for all values of the base variable to be covered by an assignment function.

Below, the rules will be knowledge-based, i.e. formulated on the basis of expert knowledge. Subsequently, methods for automatic rule generation will be discussed.

As the different possible topology changes are largely independent of one another, and in order to enable a decentralized application of the rules, a form with a single output variable is selected for the rules (Multiple Input Single Output or MISO). In this manner, it is possible that some rules can be stored and applied in the CCs, and others in the WTs. As already mentioned, no FT-related rules are formulated.

The monitoring phase usual in dynamic clustering methods and the adaptation phase are undertaken in one step when the rules are applied. Monitoring is performed to a certain extent by means of the left-hand sides of the rules. The detection of a change corresponds to fulfillment of the left-hand side of a rule whose right-hand side entails a change. Whenever the prerequisites of a rule apply, the associated rule comes into effect. However, not every rule implies an adaptation or topology change. This is because a case in which no adaptation is necessary also has to be covered by the rules.

Below, rules relating to the four different clustering measures (CC creation, CC deletion, CC handover and WT handover) are developed for the case of the local network under consideration, and individually explained. For CCs, a rule base different from that for WTs is defined, since they have to make different decisions.

### EXAMPLE 1

We begin with the CC rule base and particularly the rules for creating an additional CC:

1. IF Traffic CC=“Big” AND Traffic neighboring CCs=“Big” AND Speed CC candidates=“Small”

THEN CC creation=“yes” AND ESSENTIAL=“no” AND CC creation reason traffic=“yes”.

This rule provides that a new CC is to be created if both the own and the neighboring cluster have reached their capacity limits. The prerequisite here is that a suitable WT moving at a low speed can be made into a CC. All speed-related prerequisites are to be regarded as optional and are not used in, for example, a performance evaluation of the method. The creation of a new CC is not regarded as essential as it is a preventive measure to avoid capacity overloads.

2. IF Traffic CC=NOT “Big” THEN CC creation=“no”.

This rule is the counterpart of the previous rule. If the traffic load within a cluster is not yet big, the creation of an additional cluster is not necessary.

3. IF Traffic neighboring CCs=NOT “Big” THEN CC creation=“no”.

This rule describes a further situation in which the first rule is not applied. If the traffic load within the neighboring cluster is not big, again no new cluster should be opened. It should be noted that rules relating to the context of the WT handover will be preceded by a rule which, in the event that Traffic neighboring CCs=“Small” applies, will require a WT handover if certain other prerequisites are fulfilled.

4. IF Speed CC candidates=NOT “Small” THEN CC creation=“no”.

If all CC candidates are moving at a speed of at least “Medium Small”, no new cluster should be opened. This rule represents the last counter-example to the first one, and may (optionally) be stored and applied by all CCs.

### EXAMPLE 2

The following rules could be set up in respect of the deletion of a cluster:

1. IF Traffic CC=“Small” AND Traffic neighboring CCs=“Small” AND Number of WTs=“Small” AND “WTs supplied”

THEN CC deletion=“yes” AND CC deletion reason number of WTs=“yes”.

If a CC has to bear only a small amount of traffic and, in particular, only a very small number of WTs and FTs are associated, the CC can delete the cluster. The prerequisite, however, is that the neighboring clusters also have just a small traffic load and that, after notification but before execution of the deletion, all associated WTs can change to a neighboring cluster received with an adequate level. Adequate could mean, for instance, that a WT concerned receives the other CC at least at the upper limit level of the assignment function of the linguistic term “Level=Medium”. The condition “WTs supplied” is an example of how a sharp condition can be incorporated into the fuzzy rules. “WTs supplied” represents a binary variable that assumes the value 1 if the limit level for the reception of the new CC is exceeded for all WTs concerned, and if, simultaneously, the new CC is capable of accommodating the WT, including consideration of the traffic load. The last condition can be formulated in such a way that, in accommodating the WT, the traffic load in the cluster in question must not rise above a certain value. “WTs supplied” assumes the value 0 as soon as these conditions are infringed for a single WT.

2. IF Traffic CC=NOT “Small” THEN CC deletion=“no”.

This is the first counterpart to the previous rule.

3. IF Traffic neighboring CCs=NOT “Small” THEN CC deletion=“no”.

This rule is the second counterpart to the first CC deletion rule.

4. IF Number of WTs=NOT “Small” THEN CC deletion=“no”.

This rule is the third counterpart to the above cluster deletion rule.

5. IF NOT “WTs supplied” THEN CC deletion=“no”.

If not all WTs can be transferred to a different cluster, the CC should not delete its cluster.

### EXAMPLE 3

Rules relating to cluster shifting or CC handover are now set up. The rules are executed by all CCs:

1. IF RSS mean-value difference=“Big” AND Time since CC handover=“Big”

AND Speed CC candidate=“Small” AND Level CC candidate=“MEDIUM BIG” OR “BIG”

THEN CC handover=“yes” AND ESSENTIAL=“no” AND CC handover reason RSS=“yes”.

If the difference between the average RSS value of the CC candidate that exhibits the maximum average RSS value, and the average RSS value of the current CC is big, a CC handover may be expedient. The prerequisite, however, is that the last CC handover was undertaken some time ago already. As a result of the time barrier “Time since CC handover=Big”, the clusters are provided with the desired stability. The assignment function must be defined in such a way that, below a time barrier to be selected, an assignment value of 0 applies. In this manner (in conjunction with the use of the minimum operator for linking the prerequisites) a minimum stability can be achieved. As a further (optional) prerequisite of a CC handover, it is required here that the speed of the CC candidate is small. Finally, it is a prerequisite that the old CC receives the CC candidate at a medium or high level. In simulation runs, this condition has proved useful in order to prevent a CC handover to a terminal located very far away being initiated, as a result of which other stations in the cluster would no longer be supplied. The resultant CC handover is not classified as essential.

2. IF RSS mean-value difference=“Big” AND Time since CC handover=“Big” AND Speed CC candidate=“Small” AND Level CC candidate to neighboring CCs=“Small”

THEN CC handover=“yes” AND ESSENTIAL=“no” AND CC handover reason RSS=“yes”.

This is a further rule for deleting an RSS mean-value-based CC handover. The only difference from the previous rule lies in the last prerequisite. Instead of a short distance between the old CC and the CC candidate, it is required here that the CC candidate is not located in the vicinity of other CCs. This condition is intended to prevent concentrations of CCs.

3. IF RSS mean-value difference=NOT “Big”

THEN CC handover=“no”.

This rule is the first counterpart to the two previous rules 1 and 2.

4. IF Time since CC handover=NOT “Big”

THEN CC handover=“no”.

If the last CC handover was not undertaken a long time ago, no new CC handover is to be undertaken. With this rule, it is important to make it compulsory that no CC handover is undertaken below the defined time barrier. If:
μ(NOT “Big”)=1−μ(“Big”) (6)

applies, “NOT Big” always exhibits an assignment value of 1 below the barrier. This rule represents the second counterpart to the first two CC handover rules.

5. IF Speed CC candidate=NOT “Small”

THEN CC handover=“no”.

This rule is a further (optional) counterpart to the first two CC handover rules. If the speed of the CC candidate is not small, it should not be made a CC in order not to destabilize the topology.

6. IF Level CC candidate=NOT (“MEDIUM BIG” OR “BIG”) THEN CC handover=“no”

This rule is the last counterpart to rule 1. The rule does not take effect if the CC candidate is not located in the vicinity of the old CC.

7. IF Level CC candidate to neighboring CCs=NOT “SMALL”

THEN CC handover=“no”.

This rule is the last counterpart to rule 2. The rule does not take effect if the CC candidate is located in the vicinity of other CCs.

8. IF Speed CC=(“Medium Big” OR “Big”) AND Speed CC candidates=“Small”

THEN CC handover=“yes” AND ESSENTIAL=“no” AND CC handover reason speed=“yes”.

Should it ever happen that a fast station is acting as a CC, it should relinquish the CC function as soon as a candidate with a smaller speed emerges. This rule is used by the CCs only if the speed is, in principle, to be taken into account as one of the criteria.

9. IF Speed CC=(“Small” OR “Medium Small” OR “Medium”)

THEN CC handover=“perhaps”.

This rule covers the speed ranges of the CC that were not dealt with in the previous rule. Regarding the CC handover decision, the rule is to play no part. This means that a CC handover is to be undertaken if the other rules that require a CC handover have dominated most strongly, and that the CC handover is to be omitted if the other rules tend to negate a CC handover. The rule is only applied by the CCs if the speed is, in principle, to be taken into account as one of the criteria.

10. IF Speed CC candidates=NOT “Small”

THEN CC handover=“no”.

If no individual CC candidate with a small speed is available, a CC handover should always be dispensed with. This rule represents the second counterpart to rule 8. The rule will likewise only be applied by the CCs if the speed is, in principle, to be taken into account as one of the criteria.

In addition to the CC handover rules, based on the RSS mean-value difference, the CC rule base also contains rules otherwise fully analog CC handover rules based on the in-cluster traffic difference and the connectivity difference between the CC candidate and the current CC, which will not, however, be explained in detail. At this point, the advantage becomes clear of a fuzzy rule formulation enabling multiple different criteria to be combined to form an overall decision.

### EXAMPLE 4

The last group of rules in the CC rule base concerns the WT handovers. These are CC-initiated WT handovers. They are intended purely for optimization of the network resources and therefore must not be undertaken for FTs, since their stability represents a more important objective than optimization of the network.

1. IF Traffic CC=“Big” AND Traffic neighboring CCs=“Small” AND “WT supplied”

THEN WT handover=“yes” AND ESSENTIAL=“no” AND WT handover reason traffic=“yes”.

This rule deals with the case where, although the traffic volume within the cluster is very high, there is at least one neighboring cluster in which a small traffic load prevails. In such a case, no new cluster is to be opened, but instead an attempt should be made to transfer WTs of the own cluster into the neighboring cluster. The prerequisite here, however, is that a WT that could possibly be the subject of the handover can also be accommodated by the neighboring cluster in question. The variable “WT supplied” queries this. The variable is a sharp, binary variable, which, in a similar way to the variable “WTs supplied”, checks for an adequate level and an adequate capacity of the neighboring cluster. The only difference between the variable “WT supplied” and the variable “WTs supplied” lies in the fact that the former checks the supply of a particular WT. If the conditions regarding this WT are fulfilled, it is transferred to the neighboring cluster. The application of the rule should proceed in such a way that, each time the rule is invoked, the first two conditions are checked first of all. Only if these are fulfilled to a particular degree, which is to be defined in advance, should the third condition be subsequently checked for each individual WT in the cluster. As mentioned, owing to their important role, FTs are not candidates for transfer to a different cluster. The induced WT handover is not regarded as essential.

2. IF Traffic CC=NOT “Big” THEN WT handover=“no”.

This rule is the first counterpart to the previous rule, and means that a WT handover is not necessary if the traffic in the own cluster is not big.

3. IF Traffic neighboring CCs=NOT “Small” THEN WT handover=“no”.

This rule is the second counterpart to the first rule and means that no WT handover is to be undertaken if there is no other cluster in which a small volume of traffic prevails. In this case, a new cluster is created instead (see CC creation rules).

### EXAMPLE 5

A WT rule base will now be described by way of example. The following rules relate to the question of whether the WT is to turn itself into a CC:

1. IF Level CC=“Small” AND Level neighboring CCs=“Small” THEN CC creation=“yes” AND ESSENTIAL=“yes” AND CC creation reason level=“yes”.

This rule guarantees that each station is assigned to a cluster. Irrespective of whether or not a station has previously been assigned to a cluster, the station opens a new cluster according to this rule if all CCs are received only with a very weak level, or if no CC whatever is in range. The creation of a new cluster should be regarded as essential here. The rule is executed by all WTs and by all those stations that are not yet assigned to any cluster.

2. IF Level CC=NOT “Small” THEN CC creation=“no”.

This rule is the first counterpart to the previous rule.

3. IF Level neighboring CCs=NOT “Small” THEN CC creation=“no”.

If at least one neighboring CC is received at a level of “Medium Small” or greater, no additional cluster should be created.

### EXAMPLE 6

Below, rules relating to the cluster change of an object or to WT handover are set up.

1. IF Level CC=“Small” AND Level neighboring CCs=(“Medium” OR “Medium Big” OR “Big”) THEN WT handover=“yes” AND ESSENTIAL=“yes” AND WT handover reason level=“yes”.

If the own CC is received only weakly, but another CC simultaneously supplies a level that is at least medium, a handover to this neighboring CC should be initiated. The handover is regarded as essential because, owing to the weak level, a breakdown of the connection with the previous CC threatens.

2. IF Level CC=NOT “Small” THEN WT handover=“no”.

If the level of the own CC is not small, no handover should be initiated.

3. IF Level neighboring CCs=(“Small” OR “Medium Small”) THEN WT handover=“no”.

This rule is the second counterpart to the first rule. It deals with the case where all neighboring CCs are received at not more than the medium small level. In this case, a handover of the terminal to any of the neighboring CCs would not make sense.

4. IF PER CC=“Big” AND PER neighboring CCs=“Small” THEN WT handover=“yes” AND ESSENTIAL=“yes” AND WT handover reason PER=“yes”.

If the PER at which the own CC is received is big, and simultaneously another CC with a smaller PER is received, a handover to this CC should be initiated. The handover is regarded as essential because a breakdown of the connection threatens.

5. IF PER CC=NOT “Big” THEN WT handover=“no”.

If the own CC is not received with a high PER, a terminal handover appears unnecessary. The rule is the first counterpart to the previous rule 4.

6. IF PER neighboring CCs=NOT “Small” THEN WT handover=“no”.

If there is no neighboring CC that is received with a small PER, there is no sense in initiating a handover. This applies irrespective of whether the reception situation in the own cluster is also poor. In the latter case, the rules on cluster creation take effect.

7. IF Level CC=(“Small” OR “Medium Small” OR “Medium”) AND Level difference=“Big” THEN WT handover=“yes” AND ESSENTIAL=“no” AND WT handover reason level difference=“yes”.

This rule deals with the case of a handover which suggests itself owing to a neighboring CC that can be considerably more strongly received as compared with the own CC. The rule can come into effect even if the own CC supplies a medium level. A WT handover of this kind is, of course, not essential.

8. IF Level CC=(“Small” OR “Medium Small” OR “Medium”) AND Level difference=NOT “Big” THEN WT handover=“no”.

This rule is the counterpart to the previous rule 7 and means that no WT handover should be initiated if no big level difference exists. Cases where the level of the own CC is “Medium Big” or “Big” are already covered by the rule 2 relating to WT handover. The last two rules use the level difference between the best neighboring CC and the own CC as the handover criterion. It should be noted here that it is always the sliding mean values of the level that are considered in order to exclude stochastic influences. A terminal handover algorithm that undertakes fuzzy averaging of the level differences was proposed by G. Edwards, A. Kandel and S. Ravi, “Fuzzy handover algorithms for wireless communication”, Fuzzy Sets and Systems, Volume 110, pp. 379-388, 2000. The fuzzy averaging of the level difference “Delta RSS” is calculated therein as follows:
μ(ΔRSSₙ)=max(0,μ(ΔRSSₙ₋₁)+μₙ(ΔRSSₙ)−μ_{A}(ΔRSSₙ)) (7)

μ(ΔRSSₙ) represents the decision criterion for the terminal handover. If this value exceeds the threshold of 3.0, a handover to the relevant neighboring cell is initiated. μ_{A}(ΔRSSₙ) and μ_{N} (ΔRSSₙ) represent the assignments to two fuzzy sets “Acceptable” and “Not acceptable”, as shown in FIG. 5. Equation (6) is used to measure how frequently in succession the level difference exhibits an unacceptable value.

The terminal handover criterion by G. Edwards et al. (see above) could be used in place of the last two rules.

To summarize, it can be stated that some of the rules are used for creating a new cluster of CCs and others of WTs. The rules for deleting a cluster are always executed by a CC. This corresponds to the fact that only the CC itself should decide whether or not it relinquishes the CC function. The rules regarding a cluster shift or a CC handover are also used only by CCs. Here again, a CC itself decides whether to transfer the CC function to a different station.

For the greater part, the rules relating to the WT handover are managed by the WTs themselves. These WT handovers are terminal-initiated handovers. However, a CC-initiated handover is also proposed, for which the associated rules are managed in the CCs.

Each of the said rules can additionally be weighted by the concept of certainty factors known from conventional expert systems. The output assignment function of a rule determined as the result of the inference is multiplied by the certainty factor of the rule. The certainty factor may lie between 0 and 1, for example. It is preferred if all rules are given the same weight.

After the input and output variables of the rules and the rules themselves have been defined, a decision must be made on the operating mode of the inference machine. Essentially, this decision concerns the choice of the operators to be used. The operator for linking the prerequisites of a rule, the implication operator for scaling the output variables and the operator for aggregation of the rules must then be defined. It has also already been mentioned that a negation operator has been adopted according to definition as a complement. The arithmetic sum was selected for the OR-operation.

As is usual with most fuzzy control systems, a single-rule-based inference is to be undertaken. The question of the aggregation of the prerequisites of a rule initially arises here. The minimum operator is mostly used for this purpose. One reason is that a rule is maximally applicable to the degree that corresponds to the degree of fulfillment of the least applicable prerequisite of the rule. It should be made clear at this point, however, that this rule of thumb is fulfilled by all T-standards because, as has been demonstrated, the minimum operator maps T-standards above all others. This means that, using the minimum operator, the operator is selected that still just fulfils the rule of thumb but simultaneously maximizes the degree of fulfillment in that no linkage of the prerequisites is undertaken. For the method developed here, this characteristic of the minimum operator appears desirable, so this operator is selected for aggregation of the prerequisites. It is important to the case under consideration that, when the minimum operator is used, sharp conditions can be taken into account. A sharp condition here means a degree of fulfillment from the set {0,1}. If a sharp condition is not fulfilled, the minimum operator (like any T-standard) guarantees that the resultant degree of fulfillment of the rule as a whole is likewise 0.

The next operator to be selected concerns the type of implication. In the context of fuzzy control, one of the following two operators is used in most systems with rules of the Mamdani type:
Mamdani Inference: μ_{M}(y)=min(μ(x*),μ(y))
Scaled Inference: μ_{S}(y)=μ(x*)μ(y) (8)

The degree of fulfillment of the prerequisites for a specific input vector x* is also designated here. Where the minimum operator is used for aggregation of the prerequisites, we obtain:
μ_{M}(y)=min(μ(x₁*), . . . , μ(xₚ*),μ(y))
μ_{S}(y)=μ(x₁*) . . . μ(xₚ*)μ(y) (9)

FIG. 6 illustrates the two inference operations graphically using an example with one input variable. It is clear why the Mamdani implication is also designated clipping.

In this invention, scaled inference is preferably chosen, since this represents the faster operation computationally.

Finally, the assignment functions of the output variables resulting from the rules must be aggregated into an assignment function per output variable. In the case under consideration, the aggregation of the rules may be undertaken separately for each clustering operation, since, without exception, the rules are formulated in MISO form. However, it must also be noted that, in the case of decentralized execution of the rules, only those rules that are also managed at the same location or by the same station can be aggregated. This means that the rules in the CC rule base are aggregated by all CCs, whereas the WTs evaluate all rules of the WT rule base. All S-standards are possible aggregation operators of the assignment functions. The conventional Zadeh combining operator is the maximum operator. The maximum operator maps below all other S-standards. The decision as to selection of the aggregation operator is closely related to the selection of the defuzzification operator. This decision should therefore be made jointly with the selection of the defuzzification operator. Among the most common operators are the center-of-sums and the center-of-area methods, which fulfill criteria such as continuity, unambiguity, plausibility, computational efficiency and multiple counting. The authors take multiple counting to mean the requirement that a defuzzification rule should take into account whether a linguistic output value has been output more than once, i.e. by different rules. The difference between the center-of-area and the center-of-sums method is illustrated in FIGS. 7 and 8.

In the center-of-area method, the individual assignment functions are aggregated by the maximum operator, and subsequently the output value is determined as the key point of the resultant assignment function.

FIG. 8 indicates, by way of the dark-gray coloration of the overlapping area, that, in the center-of-sums method, the arithmetic sum is used as the aggregation operator, as a result of which the dark area is calculated twice as compared with the center-of-area method.

For the invention, the center-of-area rule is chosen as the aggregation and defuzzification method. The method has the useful property that all rules with a degree of fulfillment greater than zero influence the output decision. Mathematically, the center-of-area aggregation and defuzzification rule is as follows in the discrete case:

$${y}^{*} = \frac{{\sum }_{l = 1}^{L} {y}_{l} {\sum }_{r = 1}^{R} {μs}_{( r )} ( {y}_{l} )}{{\sum }_{l = 1}^{L} {\sum }_{r = 1}^{R} {{μ}_{S}}^{( r )} ( {y}_{l} )} \qquad ( 10 )$$

In the case of continuous assignment functions, the following applies:

$${y}^{*} = \frac{\int y \cdot {\sum }_{r = 1}^{R} {μs}_{( r )} ( y ) ⅆ y}{\int {\sum }_{r = 1}^{R} {{μ}_{S}}_{( r )} ( y ) ⅆ y} \qquad ( 11 )$$

In the formulae, [μ_{S}(r)(y₁) represents the scaled assignment function of the output variables in the r-th rule at the point y₁. The use of the scaled inference } has already been described. The number of rules managed in respect of these output variables has been designated R in the formulae.

A decision should be made regarding each of the four non-FT-related clustering operations as to whether the operation is undertaken or not. Owing to the symmetry of the selected assignment functions in FIG. 4, the value y*=0.5, for instance, could be defined as the decision limit. If the defuzzified value lies above this limit, the topology change is undertaken; if it lies below the limit value, the change is not undertaken. By shifting the threshold value in the direction of greater (or smaller) values, it can be achieved that “perhaps” recommendations tend to contribute to a “no decision” (or “yes decision,” respectively).

Decision-making by means of the threshold value is also used for the output variable, which indicates whether the clustering operation is essential or not. As regards the output variables that retain the reason for the topology change, the reason that has the maximum degree of assignment to the assignment function “yes” is selected.

As regards the FT-related topology changes, no rules are formulated, since a special algorithm, which is the subject of DE 100 53 854.1, has been developed for selection of the FTs. In its distributed version, the algorithm can be executed by the CCs and used to control the initiation of FT creation and FT handover events. FT deletion events are initiated by the FTs themselves, specifically if an FT no longer receives one of the two connected CCs at an adequate level. In a case of this kind, the FT initially attempts to find another WT that could take on the FT function. If, however, no suitable candidate is in range, the station must compulsorily relinquish the FT function.

1. A method for organizing the topology of a network with a multiplicity of stations grouped in clusters,
with the following steps:
provision of a system of rules that define the arrangement of stations in clusters;
classification of the stations into one or more categories in accordance with the rules and arrangement of the stations in clusters on the basis of this classification;
determination of changes affecting the topology of the network;
adaptation, taking account of the rules, of at least the arrangement of the stations in clusters on the basis of the changes;
characterized in that:
a multiplicity of permitted topology changes of the network are pre-defined;
at least one of the input variables for the rules is coded by fuzzy logic, dual logic or other logic; and
at least one of the rules generates at least one output variable from coded input variables as a function of the changes affecting the topology of the network;
each of said output variables being a decision variable for a permitted network topology change to be made.

2. A method as claimed in claim 1, characterized in that at least one input variable is fuzzy-coded.

3. A method as claimed in claim 1, characterized in that the network topology change is:
the creation of a cluster,
the deletion of a cluster,
the shifting of a cluster, or
the cluster change of a station.

4. A method as claimed in claim 2, characterized in that the fuzzy-coded input variable is a linguistic variable.

5. A method as claimed in claim 1, characterized in that at least one of the rules is of the Mamdani type.

6. A network with a multiplicity of stations which are grouped in clusters, with:
a memory device in at least one of the stations in which a system of rules defining the arrangement of stations in clusters is stored;
a device for classifying the stations into one or more categories in accordance with the rules, and for arranging the stations in clusters on the basis of the classification;
a device for determining changes affecting the topology of the network; and
a device for adapting at least the arrangement of the stations in clusters on the basis of the changes while, observing the rules;
characterized in that:
a multiplicity of permitted network topology changes is stored in the memory device;
a device is provided for coding at least one of the input variables for the rules in accordance with fuzzy logic, dual logic or other logic;
wherein at least one of the rules generates at least one output variable from coded input variables as a function of the changes affecting the topology of the network, and each of these output variables is a decision variable for a permitted network topology change to be made.

7. A network as claimed in claim 6, characterized in that the device for coding operates with fuzzy logic.

8. A network as claimed in claim 6, characterized in that every cluster includes a central controller, which is a station of the network, wherein the controller itself executes at least the topology changes relating to its existence and/or function.

9. A network as claimed in claim 8, characterized in that at least one station is provided as a forwarder which participates in the communication of two clusters, wherein the network permits the following as additional topology changes:
creation of a forwarder;
deletion of a forwarder;
transfer of the forwarder function to a different station.

10. The use of a method as claimed in claim 1 in conventional data analysis, wherein the stations are the objects of the data analysis.
